(19) United States
(12) Patent Application Publication
(10) Pub. No.: US 2012/0271823 A1
(43) Pub. Date: Oct. 25, 2012

(54) AUTOMATED DISCOVERY OF CONTENT AND METADATA

(75) Inventors: Joonas Asikainen, Zurich (CH); Brian Kenneth Vogel, Santa Clara, CA (US); John Johansen, Honolulu, HI (US)

(73) Assignee: ROVI TECHNOLOGIES CORPORATION, Santa Clara, CA (US)

(21) Appl. No.: 13/093,341

(22) Filed: Apr. 25, 2011

(51) Int. Cl. G06F 17/30

(52) U.S. Cl. 707/736; 707/E17.102; 707/E17.028

(57) ABSTRACT

A system for discovering content and metadata includes a processor communicatively coupled to a communication network and a database. The processor determines whether an end portion of a portion of content has been received based on the portion of content and/or metadata. The processor generates a content fingerprint based on the portion of content if the end portion has been received. The content fingerprint and/or the metadata are stored in the database.

### BACKGROUND

1. Field

Example aspects of the present invention generally relate to content and metadata, and more particularly to automated discovery of content and metadata.

2. Related Art

Metadata is generally understood to mean data that describes other data, such as the content of digital recordings. For instance, metadata can be information relating to an audio track, such as title, artist, album, track number, and other information. Such metadata is sometimes associated with the audio track in the form of tags stored in the audio track of a CD, DVD, or other type of digital file.

Unfortunately, metadata stored along with corresponding digital content is sometimes inaccurate. It would be useful to have a comprehensive database of accurate content identifiers and metadata for use in a system for recognizing and correcting inaccurate metadata. One technical challenge in doing so involves how to generate and maintain such a database to include a broad range of accurate content identifiers and metadata, particularly in view of the rapid pace at which new content and metadata are produced.

### BRIEF DESCRIPTION

The example embodiments described herein meet the above-identified needs by providing systems, methods, and computer program products for automated discovery of content and metadata. A system for discovering content and metadata includes a processor communicatively coupled to a communication network and a database. The processor determines whether an end portion of a portion of content has been received based on the portion of content and/or metadata. The processor generates a content fingerprint based on the portion of content if the end portion has been received. The content fingerprint and/or the metadata are stored in the database.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings.

FIG. 1 is a diagram of a system for automated discovery of content and metadata.

FIG. 2 is a flowchart diagram showing an exemplary procedure for generating a database of content fingerprints and metadata.

FIG. 3 is a flowchart diagram showing an exemplary procedure for performing data-mining on content fingerprints and metadata.

FIG. 4 is a block diagram of a computer for use with various example embodiments of the invention.

### DETAILED DESCRIPTION

### I. Overview

The example embodiments of the invention presented herein are directed to systems, methods, and computer program products for automated discovery of content and metadata broadcasted by an Internet radio web site. This description is not intended to limit the application of the example embodiments presented herein. In fact, after reading the following description, it will be apparent to one skilled in the relevant art(s) how to implement the following example embodiments in alternative environments, such as a web services-based environment, a satellite-based environment, a television-based environment, a radio-based environment, an audio-based environment, a video-based environment, an audio/video-based environment, etc., which each communicate content.

### II. Definitions

Some terms are defined below for easy reference. However, it should be understood that the defined terms are not rigidly restricted to their definitions. A term may be further defined by its use in other sections of this description.

“Album” means a collection of tracks. An album is typically originally published by an established entity, such as a record label (e.g., a recording company such as Warner Brothers and Universal Music).

“Attribute” means a metadata item corresponding to a particular characteristic of a portion of content. Each attribute falls under a particular attribute category. Examples of attribute categories and associated attributes for music include cognitive attributes (e.g., simplicity, storytelling quality, melodic emphasis, vocal emphasis, speech like quality, strong beat, good groove, fast pace), emotional attributes (e.g., intensity, upbeatness, aggressiveness, relaxing, mellowness, sadness, romance, broken heart), aesthetic attributes (e.g., smooth vocals, soulful vocals, high vocals, sexy vocals, powerful vocals, great vocals), social behavioral attributes (e.g., easy listening, wild dance party, slow dancing, workout, shopping mall), genre attributes (e.g., alternative, blues, country, electronic/dance, folk, gospel, jazz, Latin, new age, R&B/soul, rap/hip hop, reggae, rock), sub genre attributes (e.g., blues, gospel, motown, stax/memphis, philly, doo wop, funk, disco, old school, blue eyed soul, adult contemporary, quiet storm, crossover, dance/techno, electro/synth, new jack swing, retro/alternative, hip hop, rap), instrumental/vocal attributes (e.g., instrumental, vocal, female vocalist, male vocalist), backup vocal attributes (e.g., female vocalist, male vocalist), instrument attributes (e.g., most important instrument, second most important instrument), etc.

Examples of attribute categories and associated attributes for video content include genre (e.g., action, animation, children and family, classics, comedy, documentary, drama, faith and spirituality, foreign, high definition, horror, independent, musicals, romance, science fiction, television, thrillers), release date (e.g., within past six months, within past year, 1980s), scene type (e.g., foot-chase scene, car-chase scene, nudity scene, violent scene), commercial break attributes (e.g., type of commercial, start of commercial, end of commercial), actor attributes (actor name, scene featuring actor), soundtrack attributes (e.g., background music occurrence, background song title, theme song occurrence, theme song title), interview attributes (e.g., interviewer, interviewee, topic of discussion), etc.

Other attribute categories and attributes are contemplated and are within the scope of the embodiments described herein.

“Audio Fingerprint” (e.g., “fingerprint”, “acoustic fingerprint”, “digital fingerprint”) is a digital measure of certain acoustic properties that is deterministically generated from an audio signal that can be used to identify an audio sample and/or quickly locate similar items in an audio database. An audio fingerprint typically operates as a unique identifier for a particular item, such as, for example, a CD, a DVD and/or a Blu-ray Disc. An audio fingerprint is an independent piece of data that is not affected by metadata. Rovi™ Corporation has databases that store over 25 million unique fingerprints for various audio samples. Practical uses of audio fingerprints include without limitation identifying songs, identifying records, identifying melodies, identifying tunes, identifying advertisements, monitoring radio broadcasts, monitoring multipoint and/or peer-to-peer networks, managing sound effects libraries and identifying video files.

“Audio Fingerprinting” is the process of generating an audio fingerprint. U.S. Pat. No. 7,277,766, entitled “Method and System for Analyzing Digital Audio Files,” which is herein incorporated by reference in its entirety, provides an example of an apparatus for audio fingerprinting an audio waveform. U.S. Pat. No. 7,451,078, entitled “Methods and Apparatus for Identifying Media Objects,” which is herein incorporated by reference in its entirety, provides an example of an apparatus for generating an audio fingerprint of an audio recording. U.S. patent application Ser. No. 12/686,779, entitled “Rolling Audio Recognition,” which is herein incorporated by reference in its entirety, provides an example of an apparatus for performing rolling audio recognition of recordings. U.S. patent application Ser. No. 12/686,804, entitled “Multi-Stage Lookup for Rolling Audio Recognition,” which is herein incorporated by reference in its entirety, provides an example of performing a multi-stage lookup for rolling audio recognition.

“Blu-ray” and “Blu-ray Disc” mean a disc format jointly developed by the Blu-ray Disc Association, and personal computer and media manufacturers including Apple, Dell, Hitachi, HP, JVC, LG, Mitsubishi, Panasonic, Pioneer, Philips, Samsung, Sharp, Sony, TDK and Thomson. The format was developed to enable recording, rewriting and playback of high-definition (HD) video, as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (about 405 nm) is that it has a shorter wavelength than a red or infrared laser (about 650-780 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have substantially similar physical dimensions as a traditional CD or DVD.

“Chapter” means an audio and/or video data block on a disc, such as a Blu-ray Disc, a CD or a DVD. A chapter stores at least a portion of an audio and/or video recording.

“Compact Disc” (CD) means a disc used to store digital data. The CD was originally developed for storing digital audio. Standard CDs have a diameter of 740 mm and can typically hold up to 80 minutes of audio. There is also the mini-CD, with diameters ranging from 60 to 80 mm. Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is about 650-780 nm, and thus the light of a standard CD laser typically has a red color.

“Consumer,” “data consumer,” and the like, mean a consumer, user, client, and/or client device in a marketplace of products and/or services.

“Content,” “media content,” “content data,” “multimedia content,” “program,” “multimedia program,” and the like are generally understood to include music albums, television shows, movies, games, videos, and broadcasts of various types. Similarly, “content data” refers to the data that includes content. Content (in the form of content data) may be stored on, for example, a Blu-Ray Disc, Compact Disc, Digital Video Disc, floppy disk, mini disk, optical disc, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device.

“Content fingerprint” means an audio fingerprint and/or a video fingerprint.

“Content information,” “content metadata,” and the like refer to data that describes content and/or provides information about content. Content information may be stored in the same (or neighboring) physical location as content (e.g., as metadata on a music CD or streamed with streaming video) or it may be stored separately.

“Content source” means an originator, provider, publisher, distributor and/or broadcaster of content. Example content sources include television broadcasters, radio broadcasters, Web sites, printed media publishers, magnetic or optical media publishers, and the like.

“Content stream,” “data stream,” “audio stream,” “video stream,” “multimedia stream” and the like means data that is transferred at a rate sufficient to support such applications that play multimedia content. “Content streaming,” “data streaming,” “audio streaming,” “video streaming,” “multimedia streaming,” and the like mean the continuous transfer of data across a network. The content stream can include any form of content such as broadcast, cable, Internet or satellite radio and television, audio files, video files.

“Data correlation,” “data matching,” “matching,” and the like refer to procedures by which data may be compared to other data.

“Data object,” “data element,” “dataset,” and the like refer to data that may be stored or processed. A data object may be composed of one or more attributes (“data attributes”). A table, a database record, and a data structure are examples of data objects.

“Database” means a collection of data organized in such a way that a computer program may quickly select desired pieces of the data. A database is an electronic filing system. In some implementations, the term “database” may be used as shorthand for “database management system.”

“Data structure” means data stored in a computer-usable form. Examples of data structures include numbers, characters, strings, records, arrays, matrices, lists, objects, containers, trees, maps, buffer, queues, matrices, look-up tables, hash lists, booleans, references, graphs, and the like.

“Device” means software, hardware or a combination thereof. A device may sometimes be referred to as an apparatus. Examples of a device include without limitation a software application such as Microsoft Word™, a laptop computer, a database, a server, a display, a computer mouse, and a hard disk.

“Digital Video Disc” (DVD) means a disc used to store digital data. The DVD was originally developed for storing digital video and digital audio data. Most DVDs have substantially similar physical dimensions as compact discs (CDs), but DVDs store more than six times as much data. There is also the mini-DVD, with diameters ranging from 60 to 80 mm. DVD technology has been adapted and expanded to include DVD-ROM, DVD-R, DVD+R, DVD-RW, DVD+RW and DVD-RAM. The wavelength used by standard DVD lasers is about 605-650 nm, and thus the light of a standard DVD laser typically has a red color.

“Fuzzy search,” “fuzzy string search,” and “approximate string search” mean a search for text strings that approximately or substantially match a given text string pattern. Fuzzy searching may also be known as approximate or inexact matching. An exact match may inadvertently occur while performing a fuzzy search.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with, or pointing to, an object in memory.

“Metadata” means data that describes data. More particularly, metadata may be used to describe the contents of recordings. Such metadata may include, for example, a track name, a song name, artist information (e.g., name, birth date, discography), album information (e.g., album title, review, track listing, sound samples), relational information (e.g., similar artists and albums, genre) and/or other types of supplemental information such as advertisements, links or programs (e.g., software applications), and related images. Other examples of metadata are described herein. Metadata may also include a program guide listing of the songs or other audio content associated with multimedia content. Conventional optical discs (e.g., CDs, DVDs, Blu-ray Discs) do not typically contain metadata. Metadata may be associated with a recording (e.g., a song, an album, a video game, a movie, a video, or a broadcast such as a radio, television or Internet broadcast) after the recording has been ripped from an optical disc, converted to another digital audio format and stored on a hard drive. Metadata may be stored together with, or separately from, the underlying data that is described by the metadata.

“Network” means a connection between any two or more computers, which permits the transmission of data. A network may be any combination of networks, including without limitation the Internet, a network of networks, a local area network (e.g., home network, intranet), a wide area network, a wireless network and a cellular network.

“Occurrence” means a copy of a recording. An occurrence is preferably an exact copy of a recording. For example, different occurrences of a same pressing are typically exact copies. However, an occurrence is not necessarily an exact copy of a recording, and may be a substantially similar copy. A recording may be an inexact copy for a number of reasons, including without limitation an imperfection in the copying process, different pressings having different settings, different copies having different encodings, and other reasons. Accordingly, a recording may be the source of multiple occurrences that may be exact copies or substantially similar copies. Different occurrences may be located on different devices, including without limitation different user devices, different MP3 players, different databases, different laptops, and so on. Each occurrence of a recording may be located on any appropriate storage medium, including without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Occurrences may be compiled, such as in a database or in a listing.

“Pressing” (e.g., “disc pressing”) means producing a disc in a disc press from a master. The disc press preferably produces a disc for a reader that utilizes a laser beam having a wavelength of about 650-780 nm for CD, about 605-650 nm for DVD, about 405 nm for Blu-ray Disc or another wavelength as may be appropriate.

“Program,” “multimedia program,” “show,” and the like include video content, audio content, applications, animations, and the like. Video content includes television programs, movies, video recordings, and the like. Audio content includes music, audio recordings, podcasts, radio programs, spoken audio, and the like. Applications include code, scripts, widgets, games and the like. The terms “program,” “multimedia program,” and “show” include scheduled content (e.g., broadcast content and multicast content) and unscheduled content (e.g., on-demand content, pay-per-view content, downloaded content, streamed content, and stored content).

“Recording” means media data for playback. A recording is preferably a computer readable recording and may be, for example, a program, a music album, a television show, a movie, a game, a video, a broadcast of various types, an audio track, a video track, a song, a chapter, a CD recording, a DVD recording and/or a Blu-ray Disc recording, among other things.

“Server” means a software application that provides services to other computer programs (and their users), in the same or another computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” and “application” mean a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++, and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a record label (e.g., recording company). A song may have many different versions, for example, a radio version and an extended version.

“System” means a device or multiple coupled devices. A device is defined above.

A “tag” means an item of metadata, such as an item of time-localized metadata.

“Tagging” means associating at least a portion of content with metadata, for instance, by storing the metadata together with, or separately from, the portion of content described by the metadata.

“Theme song” means any audio content that is a portion of a multimedia program, such as a television program, and that recurs across multiple occurrences, or episodes, of the multimedia program. A theme song may be a signature tune, song, and/or other audio content, and may include music, lyrics, and/or sound effects. A theme song may occur at any time during the multimedia program transmission, but typically plays during a title sequence and/or during the end credits.

“Time-localized metadata” means metadata that describes, or is applicable to, a portion of content, where the metadata includes a time span during which the metadata is applicable. The time span can be represented by a start time and end time, a start time and a duration, or any other suitable means of representing a time span.

“Track” means an audio/video data block. A track may be on a disc, such as, for example, a Blu-ray Disc, a CD or a DVD.

“User device” (e.g., “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a television (TV), a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder (DVR), a set top box (STB), a network attached storage (NAS) device, a gaming device, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™

“Web page” means any documents written in mark-up language including without limitation HTML (hypertext mark-up language) or VRML (virtual reality modeling language), dynamic HTML, XML (extensible mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### III. System

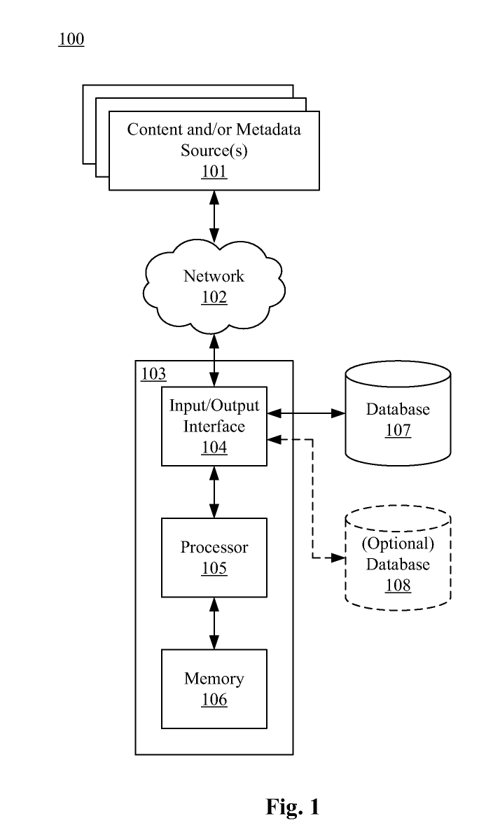

FIG. 1 is a diagram of a system 100 for automated discovery of content and metadata. System 100 includes one or more source(s) 101 of content and/or metadata. Source(s) 101 broadcast content, such as audio content, via communication network 102, such as an Internet Protocol (IP) network. Examples of source 101 include an Internet radio web site, a satellite broadcast provider, a television broadcast provider, a radio broadcast provider, and the like. In addition to broadcasting content, in some embodiments source 101 also broadcasts metadata associated with the content.

Content and/or metadata discovery system 103 includes input/output interface 104, which is communicatively coupled to, and provides bi-directional communication capability between, the one or more source(s) 101 via communication network 102, processor 105, database 107, and optionally database 108. Content and/or metadata broadcasted via network 102 are received by input/output interface 104 and are forwarded to processor 105 for processing.

Processor 105 is also communicatively coupled to memory 106, which contains program instructions that processor 105 executes to perform, among other tasks, functions associated with automated discovery of content and/or metadata. Example functions stored in memory 106 and executed by processor 105 include receiving, transmitting, copying, and/or comparing content and/or metadata, generating content fingerprints, performing data-mining of content and/or metadata, etc.

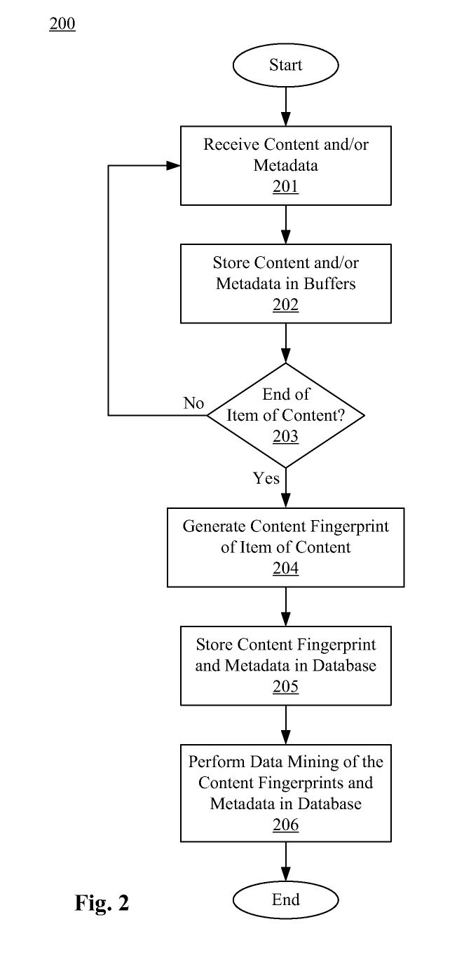

Memory 106 also contains a content buffer and a metadata buffer, which are each discussed in further detail below with respect to FIG. 2. In some embodiments, the content buffer and the metadata buffer are the same buffer. Alternatively, in lieu of the content buffer and metadata buffer being included in memory 106, content buffer and/or metadata buffer may be included within databases 107 and/or 108.

Processor 105 causes content fingerprints and/or metadata—such as metadata broadcasted by source(s) 101—to be stored in and/or retrieved from database 107 via input/output interface 104.

In some embodiments, system 100 also includes optional database 108, which, as discussed in further detail below, is used to store specific types of content fingerprints and/or metadata.

### IV. Process

FIG. 2 is a flowchart diagram showing an exemplary procedure 200 for generating a database of content fingerprints and metadata.

A. Receiving Content and/or Metadata

At block 201, content and/or metadata are received from source 101 by processor 105 via network 102 and input/output interface 104. Example content sources 101 include an Internet radio web site, a satellite radio broadcast provider, and the like.

### 1. Metadata Sources

Input/output interface 104 receives metadata in a number of ways, such as from metadata tags periodically broadcasted by source 101, from metadata published on an Internet web site in a text-based format (e.g., HTML, ASCII), and/or from metadata broadcasted in the form of a voice-over audio signal, etc.

a. Interspersed Metadata Tags

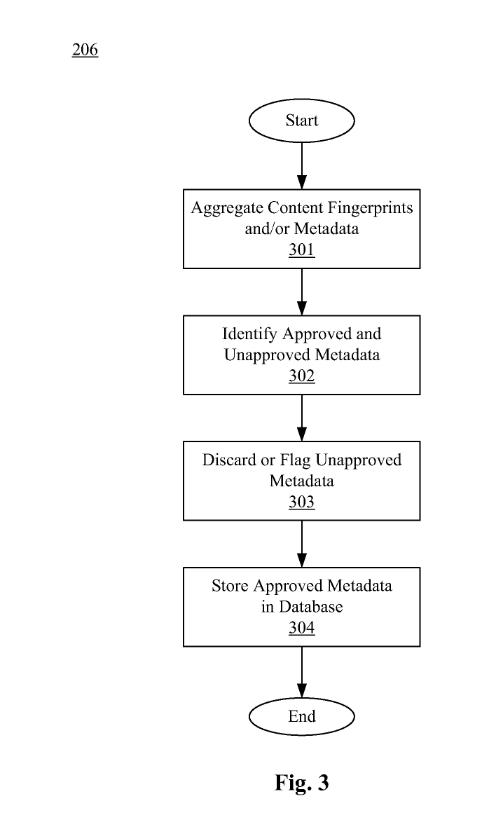

In some embodiments, in addition to broadcasting content, source 101 broadcasts, at predetermined positions interspersed throughout the broadcasted stream, packets of metadata (sometimes referred to as tags) that correspond to the content being broadcasted. For example, source 101 may broadcast metadata in the format of a string of characters, where concatenated items of metadata are separated by hyphens (e.g., “[song name]−[artist name]−[album name]”). For a particular item of content (e.g., a song), source 101 re-broadcasts this metadata at a predetermined rate, such as, for example, once per 10 seconds. Input/output interface 104 forwards the broadcasted metadata to processor 105 to be stored in the metadata buffer for further processing at a later time, as discussed in further detail below with respect to FIG. 3.

b. Text-Based Web Site Metadata

In other embodiments, source 101 publishes or displays metadata such as track title, artist name, album title, and the like, in a text-based format (e.g., HTML, ASCII) on a web site. In this case, processor 105 retrieves the text-based metadata from the web site and stores it in the metadata buffer.

c. Voice-Over

In still a further embodiment, source 101 broadcasts metadata, such as a track title, artist name, etc., in the format of a voice-over audio signal overlayed upon the content signal. In this case, processor 105 uses speech recognition to extract metadata from the voice-over audio signal and store it in the metadata buffer.

At block 202, content and/or metadata are stored in a content buffer and/or a metadata buffer, respectively, for further processing (e.g., data-mining) at a later time. In some embodiments, the content buffer and the metadata buffer are the same buffer. Alternatively, in lieu of the content buffer and metadata buffer being included in memory 106, content buffer and/or metadata buffer may be included within databases 107 and/or 108.

### 2. Identifying Content Boundaries

At block 203, processor 105 determines whether an end portion of the item of content (e.g., a song) has been received by using one of the following procedures: (1) analyzing the received metadata (metadata-based determination), (2) analyzing the received content (content-based determination), or (3) analyzing both the received metadata and the received content (combined metadata-based and content-based determination).

a. Metadata-Based Determination

In some embodiments, in addition to broadcasting content, source 101 broadcasts, at predetermined positions interspersed throughout the broadcasted stream, packets of metadata (tags) that correspond to the content. For example, source 101 may broadcast metadata in the format of a string of characters, where concatenated items of metadata are separated by hyphens (e.g., “[song name]−[artist name]−[album name]”). For a particular item of content (e.g., a song), source 101 re-broadcasts this metadata at a predetermined rate, such as, for example, once per 10 seconds.

To identify that the end portion of an item of content has been received, processor 105 compares each most recently received item of metadata to the previously received item of metadata. If the two items of metadata match, then the end portion of the item of content is deemed not to have been received. If the two items of metadata do not match, then the end portion of the item of content is deemed to have been received. In another embodiment, a new item of content is deemed to have begun.

b. Content-Based Determination

In another embodiment, processor 105 determines whether an end portion of the item of content has been received by analyzing the received content. Processor 105 periodically generates a spectrogram based on a predetermined portion of the most recently received content. To determine whether the end portion of the item of content has been received, processor 105 compares an intensity pattern of one or more of the most recently generated spectrogram(s) to a predetermined fade-out spectrogram intensity pattern. If the intensity pattern of the most recently generated spectrogram(s) match(es) the predetermined fade-out pattern, then the end portion of the item of content is deemed to have been received. If the intensity pattern of the most recently generated spectrogram(s) do(es) not match the predetermined fade-out pattern, then the end portion of the item of content is deemed not to have been received.

In another embodiment, to determine whether a new item of content has begun, processor 105 compares an intensity pattern of one or more of the most recently generated spectrogram(s) to a predetermined fade-in spectrogram intensity pattern. If the intensity pattern of the most recently generated spectrogram(s) match(es) the predetermined fade-in pattern, then a new item of content is deemed to have begun. If the intensity pattern of the most recently generated spectrogram(s) do(es) not match the predetermined fade-in pattern, then a new item of content is deemed not to have begun.

Alternatively, or in addition, processor 105 identifies the received item of content by periodically generating content fingerprints of the most recently received content and matching the generated content fingerprint to a content fingerprint stored in a database (not shown) of known content and content fingerprints. Once a generated content fingerprint no longer matches the previously matched content fingerprint, then the end portion of the item of content is deemed to have been received (and in some embodiments a new item of content is deemed to have begun).

In yet another embodiment, processor 105 uses content stream filtering to determine whether an end portion of an item of content has been received, and/or whether a new item of content has begun. U.S. patent application Ser. No. 12/840,731, entitled “Filtering Repeated Content,” which is herein incorporated by reference in its entirety, provides an example of an apparatus for filtering a content stream.

c. Combined Metadata-Based and Content-Based Determination

In yet a further embodiment, processor 105 determines whether an end portion of an item of content has been received by analyzing both the received metadata and the received content, as discussed above, respectively.

### 4. Tailoring

Additionally, in some cases each of the one or more source(s) 101 broadcasts content and/or metadata in a unique manner. For instance, each Internet radio station may broadcast metadata tags in a unique format or at a unique predetermined repetition rate. To account for any of these differences, in some embodiments, processor 105 identifies the source 101 and extracts and receives content and/or metadata based on the manner by which that source 101 is known to broadcast and/or format content and/or metadata. In this way, the efficiency and accuracy of extracting and receiving content and/or metadata may be improved. For example, in a case where source 101 is an Internet radio web site, processor 105 identifies the web site based on its IP address. Alternatively, or in addition, processor 105 identifies the web site based on identification metadata (e.g., a Uniform Resource Locator (URL) or IP address of the Internet radio web site, a genre of the currently broadcasted Internet radio station, such as “hard rock”, and/or the like) broadcasted by source 101. Once processor 105 identifies source 101, processor 105 retrieves information indicating the predetermined manner by which that particular source formats and/or broadcasts content and/or metadata. Processor 105 then extracts the broadcasted content and/or metadata in the predetermined manner specific to that source 101 by, for example, identifying and extracting discrete items of metadata that are broadcasted as a string of concatenated items of metadata.

Referring back to block 203, if processor 105 determines that the end portion of the item of content has not been received then the procedure returns to block 201 to receive and store more content and/or metadata in the content buffer and/or the metadata buffer, respectively. If processor 105 determines, at block 203, that the end portion of the item of content has been received then processor 105 ceases to store content and/or metadata in the content and/or metadata buffers and the procedure progresses to block 204.

At this point, the content buffer and metadata buffer respectively include an item of content and any corresponding received metadata. The contents of the content buffer and metadata buffer are combined into a file that includes a unique identifier that identifies the particular instance of content and metadata so that it can be distinguished from subsequently received instances of content and metadata. In some embodiments, the unique identifier includes information relating to the instance of content and/or metadata, such as an identifier of source 101 (e.g., an IP address), an identifier of the time the content and/or metadata were broadcasted, etc. In this way, it is possible to subsequently categorize content and metadata for subsequent processing (e.g., data-mining), as discussed in further detail below with respect to FIG. 3.

### B. Generating Content Fingerprint

At block 204, processor 105 generates a content fingerprint based on the content stored in the content buffer. The content fingerprint uniquely identifies an item of content. As discussed in further detail below with respect to FIG. 3, the content fingerprint is used to aggregate multiple instances of received metadata that correspond to a particular item of content.

### C. Store Content Fingerprint and Metadata

At block 205, processor 105 stores, in database 107, the content fingerprint generated at block 204 as well as any corresponding metadata stored in the metadata buffer. In particular, the content fingerprint is stored in association with its corresponding metadata.

In some embodiments, once the content fingerprint is stored with its corresponding metadata in database 107, processor 105 deletes the content from the content buffer, which makes for efficient use of memory space.

### 1. Databases

In some embodiments, system 100 includes optional database 108, which is used to store specific types of content fingerprints and/or metadata. For instance, content fingerprints and corresponding metadata that fall within a particular category, such as originating from a particular source 101, are stored in optional database 108. In this way, if it is discovered that the metadata originating from a particular source 101 is consistently unreliable or inaccurate, then that metadata can be deleted from database 108.

### D. Data-Mining

At block 206, After a predetermined quantity of content fingerprints and metadata have been received, or after a predetermined time of receiving content fingerprints and metadata has passed, data-mining is performed on the content fingerprints and metadata stored in database 107, as discussed in further detail below with respect to FIG. 3. By adjusting the predetermined quantity or time, the sample size is adjusted, which may improve the accuracy of the data-mining results. In some cases, the higher the predetermined quantity or time is, the higher the accuracy of the data-mining results are.

FIG. 3 is a flowchart diagram showing an exemplary procedure 206 for performing data-mining on content fingerprints and metadata.

### 1. Aggregation/Clustering

Content and/or metadata stored in database 107 is sometimes broadcasted from multiple different sources (e.g., different Internet radio web sites). At block 301, processor 105 compares the content fingerprints stored in database 107 to identify matching content fingerprints, which correspond to the same item of content (e.g., song). Processor 105 identifies matching content fingerprints, including those that were generated based on content originating from different sources 101. The matching content fingerprints and corresponding metadata for each common item of content are grouped. Processor 105 then analyzes and modifies the grouped metadata to produce reliable, accurate metadata, as discussed below. In some cases, the higher the number of sources 101 used, the higher the accuracy of the resulting data-mined metadata is.

### 2. Classify Metadata

At block 302, processor 105 analyzes the metadata grouped at block 301 to determine whether to approve metadata stored in database 107. In particular, processor 105 analyzes each group of aggregated content fingerprints and metadata that correspond to a single item of content to determine whether to approve the metadata. Processor 105 uses one or more predetermined algorithms to determine whether to approve metadata. For instance, in one embodiment, metadata is approved if the number of instances of matching metadata that are stored in database 107 meet a predetermined threshold. If the number of instances of matching metadata stored in database 107 do not meet the predetermined threshold then the metadata is not approved. In one embodiment, processor 105 appends a field to a header, for each file corresponding to an item of metadata, indicating whether the metadata is approved.

### 3. Discard Unapproved Metadata

At block 303, metadata of which processor 105 does not approve is deleted from database 107. Alternatively, metadata of which processor 105 does not approve may be flagged as unapproved and remain stored in database 107 for subsequent use. For instance, such metadata may be used as a basis of comparison for quickly identifying and characterizing similar subsequently captured metadata.

As another example, a single instance of metadata of, for example, a foreign-language song may initially be stored in database 107 and flagged as unapproved. Once a predetermined number of instances of metadata that matches the foreign-language metadata have been subsequently obtained and stored in database 107, the foreign-language metadata may be flagged as approved.

### 4. Fuzziness

By aggregating metadata across multiple instances and/or sources and by using a sufficiently large predetermined sample size (e.g., based on quantity and/or time), multiple instances of a particular item of content are stored in database 107, in some cases from multiple different sources 101 and/or multiple instances of playback. In this way, processor 105 can discard erroneous and/or inaccurate metadata and maintain only accurate metadata.

### E. Storing Content Fingerprints and Approved Metadata

At block 304, metadata of which processor 105 approves is flagged as approved in database 107. In one embodiment, such metadata is copied or transferred into another separate database, such as optional database 108. The resulting content of database 107 (and/or database 108), namely, the content fingerprints and corresponding approved metadata, are then used by a content recognition system to provide a robust recognition capability of content and corresponding metadata.

### V. Computer Readable Medium Implementation

The example embodiments described above such as, for example, the systems and procedures depicted in or discussed in connection with FIGS. 1, 2, and 3, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

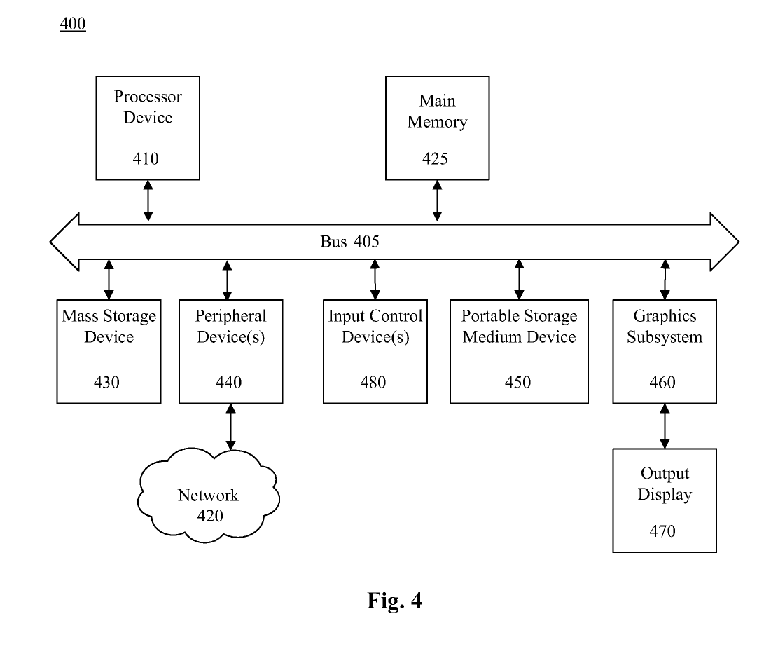

FIG. 4 is a block diagram of a general and/or special purpose computer 400, in accordance with some of the example embodiments of the invention. The computer 400 may be, for example, a user device, a user computer, a client computer and/or a server computer, among other things.

The computer 400 may include without limitation a processor device 410, a main memory 425, and an interconnect bus 405. The processor device 410 may include without limitation a single microprocessor, or may include a plurality of microprocessors for configuring the computer 400 as a multi-processor system. The main memory 425 stores, among other things, instructions and/or data for execution by the processor device 410. The main memory 425 may include banks of dynamic random access memory (DRAM), as well as cache memory.

The computer 400 may further include a mass storage device 430, peripheral device(s) 440, portable storage medium device(s) 450, input control device(s) 480, a graphics subsystem 460, and/or an output display 470. For explanatory purposes, all components in the computer 400 are shown in FIG. 4 as being coupled via the bus 405. However, the computer 400 is not so limited. Devices of the computer 400 may be coupled via one or more data transport means. For example, the processor device 410 and/or the main memory 425 may be coupled via a local microprocessor bus. The mass storage device 430, peripheral device(s) 440, portable storage medium device(s) 450, and/or graphics subsystem 460 may be coupled via one or more input/output (I/O) buses. The mass storage device 430 may be a nonvolatile storage device for storing data and/or instructions for use by the processor device 410. The mass storage device 430 may be implemented, for example, with a magnetic disk drive or an optical disk drive. In a software embodiment, the mass storage device 430 is configured for loading contents of the mass storage device 430 into the main memory 425.

The portable storage medium device 450 operates in conjunction with a nonvolatile portable storage medium, such as, for example, a compact disc read only memory (CD-ROM), to input and output data and code to and from the computer 400. In some embodiments, the software for storing an internal identifier in metadata may be stored on a portable storage medium, and may be inputted into the computer 400 via the portable storage medium device 450. The peripheral device(s) 440 may include any type of computer support device, such as, for example, an input/output (I/O) interface configured to add additional functionality to the computer 400. For example, the peripheral device(s) 440 may include a network interface card for interfacing the computer 400 with a network 420.

The input control device(s) 480 provide a portion of the user interface for a user of the computer 400. The input control device(s) 480 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 400 may include the graphics subsystem 460 and the output display 470. The output display 470 may include a cathode ray tube (CRT) display and/or a liquid crystal display (LCD). The graphics subsystem 460 receives textual and graphical information, and processes the information for output to the output display 470.

Each component of the computer 400 may represent a broad category of a computer component of a general and/or special purpose computer. Components of the computer 400 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A method for discovering content and metadata, the method comprising steps of:
receiving at least one content stream that includes a plurality of portions of content; and
for each content stream:
determining, by a processor, whether an end portion of a currently received portion of content has been received based on at least one of the currently received portion of content and metadata;
generating, by the processor, a content fingerprint based on the currently received portion of content if the end portion has been received; and
storing, in a first database, at least one of the content fingerprint and the metadata.

2. The method of claim 1, further comprising a step of:
performing, by the processor, data-mining on at least one of the content fingerprint and the metadata stored in the first database.

3. The method of claim 1, wherein the metadata includes at least one of (1) metadata broadcasted in packets via a communication network, (2) metadata published in a text based format on a web site, and (3) metadata broadcasted as a voice over audio signal.

4. The method of claim 1, further comprising a step of:
storing, in the first database, at least one of (1) an identifier of a source of the portion of content, (2) an identifier of a source of the metadata, (3) a time of receipt of the portion of content, and (4) a time of receipt of the metadata.

5. The method of claim 2, wherein the performing data mining further comprises steps of:
matching at least two content fingerprints stored in the first database; and
aggregating the metadata corresponding to the at least two matched content fingerprints.

6. The method of claim 1, wherein the portion of content includes at least one of a portion of audio content and a portion of video content.

7. The method of claim 2, wherein the performing data mining further comprises steps of:
identifying approved metadata stored in the first database, and
transferring the approved metadata from the first database to a second database.

8. A system for discovering content and metadata, the system comprising at least one processor communicatively coupled to a communication network and a first database, wherein the processor is configured to:
receive at least one content stream that includes a plurality of portions of content; and
for each content stream:
determine whether an end portion of a currently received portion of content has been received based on at least one of the currently received portion of content and metadata;
generate a content fingerprint based on the currently received portion of content if the end portion has been received; and
store, in the first database, at least one of the content fingerprint and the metadata.

9. The system of claim 8, wherein the at least one processor is further configured to:
perform data-mining on at least one of the content fingerprint and the metadata stored in the first database.

10. The system of claim 8, wherein the metadata includes at least one of (1) metadata broadcasted in packets via the communication network, (2) metadata published in a text based format on a web site, and (3) metadata broadcasted as a voice over audio signal.

11. The system of claim 8, wherein the at least one processor is further configured to:
store, in the first database, at least one of (1) an identifier of a source of the portion of content, (2) an identifier of a source of the metadata, (3) a time of receipt of the portion of content, and (4) a time of receipt of the metadata.

12. The system of claim 9, wherein the at least one processor is further configured to:
match at least two content fingerprints stored in the first database; and
aggregate the metadata corresponding to the at least two matched content fingerprints.

13. The system of claim 8, wherein the portion of content includes at least one of a portion of audio content and a portion of video content.

14. The system of claim 9, wherein the at least one processor is further configured to:
identify approved metadata stored in the first database, and
transfer the approved metadata from the first database to a second database.

15. A non-transitory computer readable medium having stored thereon sequences of instructions, the sequences of instructions including instructions, which, when executed by a processor, cause the processor to perform:
receiving at least one content stream that includes a plurality of portions of content; and
for each content stream:
determining whether an end portion of a currently received portion of content has been received based on at least one of the currently received portion of content and metadata;
generating a content fingerprint based on the currently received portion of content if the end portion has been received; and
storing, in a first database, at least one of the content fingerprint and the metadata.

16. The computer readable medium of claim 15, wherein the sequences of instructions further include instructions, which, when executed by the processor, cause the processor to perform:
performing, by the processor, data-mining on at least one of the content fingerprint and the metadata stored in the first database.

17. The computer readable medium of claim 15, wherein the metadata includes at least one of (1) metadata broadcasted in packets via a communication network, (2) metadata published in a text based format on a web site, and (3) metadata broadcasted as a voice over audio signal.

18. The computer readable medium of claim 15, wherein the sequences of instructions further include instructions, which, when executed by the processor, cause the processor to perform:
storing, in the first database, at least one of (1) an identifier of a source of the portion of content, (2) an identifier of a source of the metadata, (3) a time of receipt of the portion of content, and (4) a time of receipt of the metadata.

19. The computer readable medium of claim 16, wherein the sequences of instructions further include instructions, which, when executed by the processor, cause the processor to perform:
matching at least two content fingerprints stored in the first database; and
aggregating the metadata corresponding to the at least two matched content fingerprints.

20. The computer readable medium of claim 16, wherein the sequences of instructions further include instructions, which, when executed by the processor, cause the processor to perform:
identifying approved metadata stored in the first database, and
transferring the approved metadata from the first database to a second database.

21. The method of claim 1, wherein, for each content stream, the plurality of portions of content include portions of different content.

22. The method of claim 1, wherein, for each content stream, the end portion indicates that a new portion of content will be received.

23. The method of claim 1, wherein, for each content stream, portions of new content are received during the generation of the content fingerprint.

24. The method of claim 1,
wherein, for each content stream, the currently received portion of content is stored in a buffer until the end portion is received, and in a case where the end portion is received, the content fingerprint is generated based on the currently received portion of content that is stored in the buffer,
wherein, for each content stream, portions of new content are received during the generation of the content fingerprint.
